(19) United States
(12) Patent Application Publication
(10) Pub. No.: US 2024/0240797 A1
(43) Pub. Date: Jul. 18, 2024

(54) KITCHEN AND/OR GASTRONOMIC APPLIANCE

(71) Applicant: Welbilt Deutschland GmbH, Eglfing (DE)

(72) Inventors: Herbert FISCHHABER, Peissenberg (DE); Rainer LAMMERSKITTEN, Eglfing (DE); Arndt MANTER, Horgenzell (DE); Sebastian SIEBERT, Neubeuern (DE); Stan SMITS, Weilheim (DE); Hannes WILD, Riegsee (DE); Günter WURDINGER, Peißenberg (DE)

(21) Appl. No.: 18/413,424

(22) Filed: Jan. 16, 2024

(30) Foreign Application Priority Data
Jan. 16, 2023 (DE) 102023100845.5

(51) Int. Cl. F24C 14/00; A47J 27/04; A47J 36/00; B08B 9/00; B65D 17/00; B65D 17/34; B65D 65/40

(52) U.S. Cl. CPC F24C 14/005; A47J 27/04; A47J 36/00; B08B 9/00; B65D 17/04; B65D 17/34; B65D 65/40; A47J 2027/043

(57) ABSTRACT

The invention relates to a kitchen and/or gastronomic appliance, in particular cooking appliance, comprising a food chamber for treating and/or storing food, in particular configured as a cooking chamber, a collecting container for storing a liquid washing liquor, a washing liquor line for conducting the washing liquor out of the collecting container into the food chamber, at least one solids unit, having a receptacle for insertion of a container comprising a solid additive, a supply line leading to the receptacle for supplying a fluid that dissolves the additive, and a discharge line that leads from the receptacle in the direction of the collecting container and is intended for removing the fluid together with the dissolved additive, at least one supply line pump for pumping the fluid, preferably the washing liquor, through the at least one supply line.

### CROSS-REFERENCE TO RELATED APPLICATION

This application claims priority to German Patent Application No. DE102023100845.5, entitled “Kitchen and/or Gastronomic Appliance” and filed on Jan. 16, 2023, which is expressly incorporated by reference herein in its entirety.

### BACKGROUND

The invention relates to a kitchen and/or gastronomic appliance, in particular a cooking appliance.

### SUMMARY

The object of the present invention is that of specifying a kitchen and/or gastronomic appliance which can be cleaned in a user-friendly and reliable manner, combined with simple production and low-maintenance operation.

The object is achieved by the features of the independent claim. The dependent claims relate to preferred embodiments of the invention.

The invention discloses a kitchen and/or gastronomic appliance. The appliance is configured in particular for commercial use in gastronomy, or for domestic use in a kitchen. The appliance is preferably a cooking appliance. For example, the appliance is configured as a combi steamer. Alternatively, the appliance can be configured for example as a warming oven or baking oven.

The kitchen and/or gastronomic appliance comprises a food chamber for treating and/or storing food. Particularly preferably, the appliance comprises a housing, wherein the food chamber is arranged inside the housing. If the appliance is configured as a cooking appliance, the food chamber can also be referred to as a cooking chamber. Preferably a heating/circulating air unit is located in or on the food chamber, which unit makes it possible to heat the food chamber and/or to apply circulating air thereto. In particular, steam can also be generated by means of the heating/circulating air unit, in order to treat the food in the food chamber by means of the steam.

Furthermore, the kitchen and/or gastronomic appliance comprises a collecting container for storing a liquid washing liquor. The collecting container is preferably located under the food chamber. Particularly preferably a return line is provided, which makes it possible to guide the washing liquor out of the food chamber and back into the container. The return line can be configured as a drainage channel which leads from the food chamber into the collecting container.

The collecting container is connected to the food chamber via a washing liquor line. Said washing liquor line for is configured and arranged for conducting the washing liquor out of the collecting container into the food chamber. Particularly preferably, a washing liquor pump is provided, which conveys the washing liquor through the washing liquor line into the food chamber. In particular, the kitchen and/or gastronomic appliance is configured to distribute the washing liquor in the food chamber on the walls of the food chamber, in order to thereby clean the food chamber. The washing liquor flows together on the base of the food chamber, and can be guided back into the collecting container via the described return line.

In order to produce the washing liquor, fresh water is enriched with an additive. This additive can for example be a cleaner or a descaler or rinse aid. Within the context of the invention, it is provided that the additive is not fluid at room temperature, but rather is solid and is located in a container. A “solid” additive is preferably also understood to mean a “gel-like” additive. Additives for a plurality of cleaning processes are stored in the container, such that always only some of the additive has to be dissolved out of the container.

The kitchen and/or gastronomic appliance comprises at least one solids unit. The individual solids unit comprises at least one receptacle for insertion of the described container, which is filled with solid additive. Furthermore, the solids unit comprises a supply line which leads to the receptacle. The supply line is configured for feeding a fluid, which dissolves the additive.

Furthermore, the individual solids unit comprises a discharge line which leads from the receptacle in the direction of the collecting container. The discharge line is configured for removing the fluid, together with the dissolved additive. The discharge line preferably leads into the collecting container; however, the discharge line can also lead into another line, which then in turn leads to the collecting container.

In principle, the kitchen and/or gastronomic appliance comprises at least one of said described solids unit. As a result, the washing liquor can be enriched with at least one additive, for example cleaner. However, it is particularly preferably provided that the cleaning of the food chamber takes place in succession, using two different washing liquors. In particular, firstly a washing liquor comprising the additive “cleaner” is produced and conducted (in particular circulated) through the food chamber, and thereafter a new washing liquor having the additive “descaler” or “rinse aid” is produced and conducted (in particular circulated) through the food chamber. Therefore, the kitchen and/or gastronomic appliance preferably comprises at least two of the solids units. As a result, two receptacles are also provided, into which in each case one container can be inserted, such that one container comprising cleaner and one container comprising descaler or rinse aid can be inserted.

The first receptacle preferably has a different internal geometry from the second receptacle. This makes it possible—in the case of a corresponding design of the outside contour of different containers—for only the matching container to be able to be plugged into the respective receptacle. This prevents, for example, the container having the descaler/rinse aid from being plugged into the receptacle for the cleaner.

The receptacle, in particular the first receptacle and/or the second receptacle, is/are in particular configured for plugging in, and not for screwing in, of the respective container. In an alternative embodiment, however, the container can also be screwed in by means of threads or a bayonet connection.

The kitchen and/or gastronomic appliance comprises at least one supply line pump for pumping the fluid through the at least one supply line. As will be described in detail, when two solids units are used, two individual supply line pumps or one common supply line pump can be used. By means of the at least one supply line pump, a fluid is conveyed through the supply line as far as the receptacle. This is preferably the washing liquor from the collecting container. In addition, or alternatively, it is also provided that fresh water is pumped to the receptacle of the solids unit by means of the supply line pump.

The “washing liquor” in the collecting container can consist, at the beginning of the cleaning process, of fresh water, but is referred to as washing liquor because it is located in the collecting container. Said fluid from the collecting container and/or additional fresh water is pumped through the respective solids unit until the required or specified amount of additive has been dissolved out of the container. Thereupon or during this process, the washing liquor can circulate through the food chamber, via the washing liquor line, in order to clean said chamber. At the end of the process, the washing liquor is let out or pumped out of the collecting container in the direction of a wastewater line. In the next step, the washing liquor comprising the second additive (e.g. descaler/rinse aid) can then be produced and circulated through the food chamber, or the cleaning process of the food chamber is ended by the circulation of pure fresh water.

As already explained, the kitchen and/or gastronomic appliance preferably comprises at least two, particularly preferably exactly two, of the solids units. If, in the context of the present document, reference is made only to the solids unit, the receptacle, the supply line or the discharge line, this always describes advantageous embodiments for both solids units or selectively only for one of the two solids units.

However, in order to distinguish the two solids units from one another in individual cases, in particular for the cleaner and for the descaler/rinse aid, the following is preferably provided:

The kitchen and/or gastronomic appliance comprises a first solids unit having a first receptacle for insertion of a container comprising solid additive, in particular cleaner, a first supply line leading to the first receptacle and intended for supplying the fluid that dissolves the additive, and a first discharge line, for removing the fluid together with dissolved additive, that leads from the first receptacle in the direction of the collecting container.

The kitchen and/or gastronomic appliance furthermore comprises a second solids unit having a second receptacle for insertion of a container comprising solid additive, in particular descaler or rinse aid, a second supply line leading to the second receptacle and intended for supplying the fluid that dissolves the additive, and a second discharge line, for removing the fluid together with dissolved additive, that leads from the second receptacle in the direction of the collecting container.

Preferably, a first supply line pump for pumping the fluid through the first supply line, and a second supply line pump for pumping the fluid through the second supply line, are provided. Alternatively thereto, the kitchen and/or gastronomic appliance can comprise a common supply line pump for pumping the fluid through the first supply line and the second supply line. As already described, the pumped fluid is preferably the washing liquor from the collecting container, and/or fresh water.

When the common supply line pump is used, it is preferably provided that said pump is configured for selectively conveying the fluid into the first supply line and into the second supply line. This can be achieved for example in that the pump has one suction connection and two pressure connections, wherein the two pressure connections lead to the first supply line and to the second supply line. In this case, the pump can be configured such that it pumps selectively into the first supply line or into the second supply line, for example by means of a changing rotation direction.

Furthermore, when the common supply line pump is used, a valve downstream of the common supply line pump can also be used, wherein the valve is configured for selectively conveying the fluid into the first supply line or into the second supply line.

In particular, it is provided that the kitchen and/or gastronomic appliance comprises a controller which actuates the pumps that are used. Should a valve downstream of the common supply line pump be used, then such a valve can also be actuable by means of the controller.

The controller is preferably configured to convey fluid either through the first solids unit or through the second solids unit, but not through the two solids units simultaneously. As a result, the washing liquor is enriched either with one additive or with the other additive.

The first discharge line and the second discharge line of the two solids units can in principle lead to the collecting container separately from one another. However, it is preferably provided that the first discharge line and the second discharge line lead into a common discharge line and that said common discharge line leads into the collecting container.

The first supply line and the second supply line can begin separately from one another at the collecting container, or can branch off, separately from one another, from the washing liquor line. In a preferred embodiment, it is provided that a common supply line branches off from the collecting container or from the washing liquor line, and that this common supply line splits into the first supply line and the second supply line.

The kitchen and/or gastronomic appliance preferably comprises at least one sensor. Said sensor is configured for determining a control variable. The control variable depends on the concentration and/or density and/or turbidity and/or conductivity and/or pH of the additive. The at least one sensor is in particular arranged such that the fluid flows therearound; either the fluid that comes from the solids unit via the discharge line, or the washing liquor which is already located in the collecting container. It is possible for a plurality of the sensors to be used, which sensors may also be located at different positions, described in more detail in the following. Alternatively, sensor-less control can also be performed, by means of which a certain concentration can be produced, e.g. via purely time-controlled activation of the pumping.

The at least one sensor is preferably connected to the described controller. The controller is preferably configured to actuate the supply line pump (in particular first supply line pump and/or second supply line pump, or the common supply line pump) depending on the control variable. Furthermore, it is also provided for the washing liquor pump to be actuable depending on the control variable.

The at least one sensor is preferably configured as a conductivity sensor, and can thus detect how well the fluid conducts electrical current. The control variable is correspondingly a conductivity or a variable dependent on the conductivity. The conductivity of the fluid changes depending on the concentration of additive in the fluid.

The sensor can be located in the washing liquor line.

In addition, or alternatively, the sensor can be located in the supply line (in particular in the first supply line and/or second supply line, or in the common supply line).

In addition, or alternatively, the sensor can be located in the discharge line (in particular in the first discharge line and/or second discharge line, or in the common discharge line).

In addition, or alternatively, the sensor can be located in a circulation line. The circulation line circulates the washing liquor, bypassing the food chamber and the solids unit(s). For example, the circulation line branches off from the collecting container and leads back into the collecting container. A circulation pump can be located in the circulation line. The circulation line not only has the effect of conducting the washing liquor past the sensor, but can also ensure thorough mixing of the washing liquor.

The different positions for the sensor are to be considered as alternatives, but also in combination with one another, since it is possible to use not just one sensor, but rather also a plurality of the sensors at different positions.

As described, the kitchen and/or gastronomic appliance is configured, in particular by means of the controller, to actuate the pumping depending on the control variable. In particular, the at least one supply line pump is actuated depending on the control variable. Preferably, the kitchen and/or gastronomic appliance, in particular the controller, is configured to switch the supply line pump (in particular first supply line pump and/or second supply line pump, or common supply line pump) on and off and/or to change its speed and/or to change its discharge rate, depending on the control variable.

If the desired control variable has not yet been reached, for example, the corresponding supply line pump can be switched on. In order to correspondingly dissolve more additive, the speed of the supply line pump can be increased and/or the discharge rate can be increased. If observation of the control variable reveals, for example, that only a small amount of additive in the washing liquor is missing, the speed and/or delivery rate of the corresponding supply line pump can be reduced.

As will be described in detail with reference to the container, it is provided that at least one indicator element is embedded in the solid additive, inside the container. Said indicator element consists of an indicator substance. The indicator substance deviates from the additive, but can also be dissolved by the fluid. The kitchen and/or gastronomic appliance is preferably configured to detect an indicator variable in the fluid, which variable depends on a concentration of the indicator substance.

The indicator variable can in principle be the above-defined control variable, i.e. for example the conductivity of the fluid. The detection of the indicator variable can also take place by means of the sensor already described. For example, it is in particular provided that the indicator substance changes the conductivity in the fluid more significantly or less significantly than the additive. As a result, there is a significant change in the detected indicator variable, at the sensor as soon as the indicator substance is dissolved.

Alternatively, an additional sensor can also be used, which is specially configured for identifying the indicator variable.

The use of the indicator element comprising indicator substance in the container makes it possible, for example, to detect how much of the additive has already been dissolved out of the container. For example, if the indicator element is located in the center of the container, it is possible to detect when approximately half the additive has been used. If an indicator element is located close to the base of the container, then it is possible to detect, for example, that the additive is approximately or completely used up.

The kitchen and/or gastronomic appliance preferably comprises a protection assembly for the described sensor; in particular for protecting the sensor against contamination.

The protection assembly preferably comprises a flow element, which narrows the cross-section, upstream of the sensor, preferably directly in front of the sensor. Said flow element is configured to increase the flow rate of the fluid upstream of the sensor. As a result, any impurities on the sensor or on a possible sieve can be flushed away. The flow element is for example a cross-sectional narrowing in a line, in particular in a pipe or a tube. Particularly preferably, said flow element that narrows the cross-section is inserted in the described circulation line, wherein the sensor is then located in the circulation line.

In addition, or alternatively, for cleaning the sensor, the protection assembly provides that the kitchen and/or gastronomic appliance (in particular the controller) is configured to actuate, in a pulsating manner, a pump that conveys the fluid past the sensor, for cleaning the sensor. Said pump can be the circulation pump, the first supply line pump, the second supply line pump, the common supply line pump, or the washing liquor pump. The sensor is then arranged correspondingly in a line before or after the pump, such that any impurities detach from the sensor in the case of pulsating operation of the pump.

In addition, or alternatively to the described measures, the protection assembly for the sensor can also comprise a sieve. The sieve can be arranged upstream of the sensor, in the flow direction. However, the sieve can also be located on the sensor, and thus cover the sensor. Within the context of the invention, a sieve is in particular understood to mean everything that comprises a plurality of openings and as a result can prevent at least some dirt particles from penetrating as far as the sensor; however, the sieve is permeable for the fluid, such that the fluid can wash around the sensor.

According to a preferred embodiment, the sieve is located in the collecting container. In this case, the sensor can also be located in the collecting container and be covered by the sieve. However, it is also possible for the sieve to protect the inflow into a line leading to the sensor. At least one line, which is directed towards the sieve, in order to backflush the sieve, opens into the collecting container. This line can be a fresh water supply line, or the return line from the food chamber, or the discharge line of the solids unit.

Furthermore, it is provided that the sieve separates the sensor from a flow channel of the fluid. Said flow channel is in particular formed by a line. In this case, the sensor does not protrude into the flow of the fluid, but rather is located to the side of the flow channel. The fluid can flow through the sieve to the sensor. However, any dirt particles are held back by the sieve, and in particular transported past the sieve by the fluid. Particularly preferably, the flow channel has a cross-sectional narrowing in the region of the sieve, and can generate a flow through the sieve, and thus to the sensor, by the Venturi effect.

Instead of positioning the sensor next to the flow channel, it is preferably provided that the sensor protrudes into the flow channel—i.e. the corresponding line—of the fluid, and in this case is surrounded by the sieve. In this case, it is particularly preferable for the sensor, together with the sieve, to be arranged for tangential incident flow. Said tangential incident flow describes the circumstance that the flow channel before the sensor is offset relative to the flow channel after the sensor. This results in a relatively strong flow on either side of the sieve, and thus corresponding backflushing of the sieve.

The sieve is preferably arranged such that it can be dismantled for cleaning and/or replacement. The sieve can preferably be dismantled without tools.

During the intentional dissolving of the additive, and/or after this process, excessive dissolving of the additive may occur, because air moisture can dissolve the additive. In particular if the additives used have hygroscopic properties, the moisture from the surroundings may cause this behavior. It may therefore be the case that the additive flows out of the container, and thus out of the receptacle, as a viscous mass. In the following, said unintentionally dissolved additive is referred to as “excess additive”.

The kitchen and/or gastronomic appliance preferably comprises a siphon in the discharge line. In this case, said siphon serves as a vapor barrier between the collecting container and the at least one receptacle. This prevents vapor from penetrating out of the hot washing liquor in the collecting container as far as the receptacle, and thus as far as the container comprising the additive. Specifically, such vapor could lead to unintentional dissolving of the solid additive. The unintentionally dissolved additive could flow back in the direction of the collecting container, as a viscous mass.

In the case of use of the common discharge line for both solids units, the siphon can be located in the common discharge line. However, it is also provided for one siphon, in each case, to be arranged in the first discharge line and in the second discharge line.

Furthermore, unintentional dissolving of the solid additive can be prevented in that the additive dries as quickly as possible, in the container, after the intended dissolving. For this purpose, preferably a fan and/or a ventilation opening and/or a chimney is/are provided, the airflow of which for drying the additive leads to the receptacle and thus to the container.

The fan can blow air to the receptacle or suction it from the receptacle, as a result of which drying of the additive can be achieved. A corresponding arrangement of the ventilation opening or of the chimney also makes it possible for an airflow to be produced which leads to the receptacle and is conducted away from the receptacle, via the ventilation opening, in particular in that an airflow results, on account of temperature differences inside the appliance and outside the appliance, which can be conducted past the receptacle, and thus past the additive, when the ventilation opening or the chimney is arranged in a corresponding manner.

It is preferably provided that the at least one solids unit comprises a collecting arrangement in the discharge line for collecting the excess additive. In particular, the first solids unit comprises such a collecting arrangement, and the second solids unit also comprises such a collecting arrangement The collecting arrangements for the two solids units can be configured differently, in particular because the different additives tend towards different behavior with respect to the excess additive.

The collecting arrangement preferably comprises an intermediate container for collecting the excess additive, wherein the discharge line leads into the intermediate container and leads out of the intermediate container, onwards in the direction of the collecting container. In this case, the intermediate container can directly adjoin the receptacle or can be connected to the receptacle via a corresponding line.

The intermediate container can comprise an overflow which leads to the collecting container. As a result, fluid can collect in the intermediate container, in order to dissolve the excess additive.

A base of the intermediate container can preferably rise obliquely towards the overflow, such that the excess additive does not collect directly at the overflow, but rather at the lowest point of the intermediate container.

Particularly preferably, the overflow is configured as a suction lifter. This functions according to the principle of the Pythagoras cup. The overflow configured as a suction lifter comprises a rising flow channel, which transitions, by means of a transition, into a falling flow channel. In this case, the intermediate container can be filled higher than the transition, for self-emptying. In particular, the controller is configured to fill the intermediate container higher than the transition, by actuating the at least one supply line pump. A water level in the intermediate container that is lower than the transition makes it possible for firstly the excess additive to be dissolved in part or completely. Thereupon, the water level can be increased until it rises above the transition, in particular by actuation of the supply line pump. This results in self-emptying by means of the suction lifter.

Furthermore, a flushing line is preferably provided, which leads to the intermediate container, bypassing the additive. The flushing line preferably branches off from the line, downstream of the at least one supply line pump. The amount of fluid that flows to the additive, and the amount of fluid that flows via the flushing line directly to the intermediate container, can be defined by a valve and/or by corresponding dimensioning of the lines. Said fluid in the flushing line can be used for dissolving the excess additive in the intermediate container.

The flushing line can lead into the intermediate container. Alternatively thereto, the flushing line can suction fluid out of the intermediate container by means of a Venturi nozzle. In the Venturi nozzle or immediately after the Venturi nozzle, the fluid of the flushing line mixes with the fluid suctioned out of the intermediate container. The flushing line then in particular does not lead into the intermediate container, but rather leads into the discharge line or directly into the collecting container, downstream of the intermediate container.

In a preferred embodiment, it is provided that the intermediate container is arranged at the height of the receptacle, such that a first fluid level in the intermediate container floods the receptacle and thus the container, for dissolving the additive, and a second fluid level, which is lower than the first fluid level and greater than zero, does not flood the receptacle or floods it only to a lesser extent. If the second fluid level in the intermediate container is maintained, the excess additive, which has flowed back into the intermediate container, can dissolve. In order to dissolve even more additive out of the container, the fluid level can be increased to the first fluid level. In this case, the container is flooded at least in part, and the additive in the container is dissolved.

Instead of or in addition to the described intermediate container, the collecting arrangement can comprise a line element, which is configured for collecting the excess additive.

Particularly preferably, said line element extends over a line element length of at least 5 cm, in particular at least 10 cm. In addition, or alternatively, the line element preferably has only a small downward gradient of at most 30°, preferably at most 20°, or is oriented horizontally, or even has a rising incline relative to the horizontal.

Furthermore, the line element can comprise at least one flow resistance element, preferably a plurality of flow resistance elements, on the base of the line element.

The flow resistance element is preferably inclined, in particular transversely, to the flow direction.

As a result of the corresponding length and/or the small downward gradient and/or as a result of the at least one flow resistance element, the excess additive collects in the line element and does not flow further to the collecting container.

Preferably, the at least one receptacle, in particular the first receptacle and the second receptacle, is/are arranged over the food chamber in the housing of the kitchen and/or gastronomic appliance.

The intermediate container and/or the line element are preferably located over the food chamber.

It is preferably provided that the supply line is configured to selectively conduct the fluid to the receptacle, and thus into the container for dissolving the additive, or into the collecting arrangement. In this case, it is also possible for one partial flow to be conducted to the receptacle and another partial flow to be conducted into the collecting arrangement. In the collecting arrangement, the fluid can be used for dissolving the excess additive.

It is in particular provided that the supply line is configured to selectively conduct the fluid to the receptacle or into the collecting arrangement, depending on the pressure in the supply line, i.e. in particular by actuating the supply line pump.

For this purpose, in particular an end piece of the supply line is provided, which is configured and positioned in such a way that, at a first pressure in the supply line, the fluid is conducted into the collecting arrangement, and at a second pressure which deviates from the first pressure and is preferably higher than the first pressure, the fluid can be conducted to the receptacle, for dissolving the additive. In particular, the end piece comprises a main opening, through which the fluid emerges in the case of the second pressure, and a secondary opening, through which the fluid emerges in the case of the first pressure.

Furthermore, it is preferably provided that a fresh water supply line leads into the collecting container. Said fresh water supply line preferably comprises an actuable valve. The valve is preferably actuable by the mentioned controller. Preferably, a flow sensor is located in the fresh water supply line, in order to determine the amount of fresh water that is fed in.

Furthermore, the kitchen and/or gastronomic appliance preferably comprises a flap. Said flap covers the at least one receptacle. Particularly preferably, a flap is provided which covers both receptacles, specifically the first receptacle and the second receptacle. The flap is actuable and can thus be opened and closed, in order to insert the at least one container into the receptacle, or to remove the empty container.

The kitchen and/or gastronomic appliance preferably comprises a flap sensor, which detects whether the flap is closed and/or open. The flap sensor is particularly preferably configured as a brightness sensor, and detects whether the flap is open (“bright”) or closed (“dark”). In an alternative embodiment, the flap sensor is implemented by means of an electromechanical switch (e.g. microswitch and the like).

Furthermore, it is preferably provided that the respective solids unit comprises a container sensor. The container sensor can be actuated by the plugged-in container. It is thus possible to determine, by means of the container sensor, whether the container is plugged into the receptacle.

The receptacle, in particular the first receptacle and the second receptacle, preferably comprises a container seal, which provides sealing with respect to the inserted container.

The invention further comprises the described container, filled with solid additive, in particular cleaner or descaler/rinse aid. The container is configured for insertion, in particular plugging, into the receptacle of the described kitchen and/or gastronomic appliance.

The invention preferably furthermore comprises a system composed of the described kitchen and/or gastronomic appliance in combination with the at least one described container. The advantageous embodiments, as are described in the context of the kitchen and/or gastronomic appliance, can be advantageously applied, in a corresponding manner, to the system.

It is preferably provided that the container comprises at least one indicator element having indicator substance at a defined position in the additive. The indicator element can be dissolved from the additive by the fluid. The indicator element preferably changes the conductivity more than the additive. The indicator element thus increases or reduces the conductivity of the fluid differently from the additive.

Preferably at least two indicator elements are arranged in the additive at different positions, in order to determine the use of additive in at least two stages.

According to a variant, the container is made of plastics material, in particular single-layered and rigid. Alternatively thereto, the container is manufactured from a flexible multilayer material, wherein the multilayer material comprises at least one first layer and one second layer, wherein the first layer is made of paper or card, and the second layer is made of plastics material or metal. The multilayer material can also be referred to as a composite material. In this case, a multilayer material can be used of the kind as is used in a similar manner in drink packaging (Tetra Pak).

The container preferably comprises a main body and a lid, wherein the lid closes an opening of the main body. At this opening of the main body, the additive is exposed.

It is preferably provided that the lid is connected to the main body of the container via a pull tab.

In addition, or alternatively, it is preferably provided that the lid is adhesively bonded or welded to the main body. Said adhesive bonding or welding is released when the lid is removed.

In addition, or alternatively, it is preferably provided that the lid can be removed from the main body without tools.

In addition, or alternatively, it is preferably provided that the lid can be removed from the main body without destruction, and thus can in particular be placed thereon again. As a result, the container can be removed and closed in the event of long operating breaks.

In addition, or alternatively, it is preferably provided that the container comprises a connecting portion which connects the removed lid to the main body. This ensures that the removed lid is not lost, and is still available, when the container is removed, for closing the container.

### BRIEF DESCRIPTION OF THE DRAWINGS

Further details, advantages and features of the present invention will emerge from the following description of an embodiment, with reference to the drawings, in which:

FIG. 1 shows two views of a kitchen and/or gastronomic appliance according to the invention, according to one embodiment,

FIG. 2 is a schematic view of the fluid circuits in the kitchen and/or gastronomic appliance according to the invention, according to the embodiment,

FIG. 3 is a schematic detailed view of the kitchen and/or gastronomic appliance according to the embodiment, with positions of the sensors,

FIGS. 4 to 8 are schematic detailed views of the kitchen and/or gastronomic appliance according to the embodiment, according to the embodiment, for illustrating the protection assembly of the sensor,

FIG. 9 is a schematic detailed view of the kitchen and/or gastronomic appliance according to the embodiment, comprising a common supply line pump,

FIG. 10 is a schematic detailed view of the kitchen and/or gastronomic appliance according to the embodiment, according to the embodiment comprising a siphon,

FIG. 11 is a schematic detailed view of the kitchen and/or gastronomic appliance according to the embodiment, according to the embodiment comprising a fan,

FIGS. 12 to 19 are schematic detailed views of the kitchen and/or gastronomic appliance according to the embodiment, according to the embodiment comprising a collecting arrangement together with an intermediate container,

FIGS. 20 to 22 are schematic detailed views of the kitchen and/or gastronomic appliance according to the embodiment, according to the embodiment comprising a collecting arrangement together with a line element,

FIGS. 23 and 24 show a first variant of a container according to the invention, for use together with the kitchen and/or gastronomic appliance according to the invention, according to the embodiment,

FIG. 25 is a schematic view for arranging indicator elements in the container according to the invention, and

FIGS. 26 and 27 are schematic views of a further variant of the container according to the invention, for use in the kitchen and/or gastronomic appliance according to the invention, according to the embodiment.

### DETAILED DESCRIPTION

In the following, the configuration of a kitchen and/or gastronomic appliance 1 according to one embodiment will be explained in greater detail, with reference to the drawings. In this case, the drawings are purely schematic illustrations showing the kitchen and/or gastronomic appliance 1 and various optional embodiments. Unless explicitly mentioned otherwise, reference is always made to all the drawings.

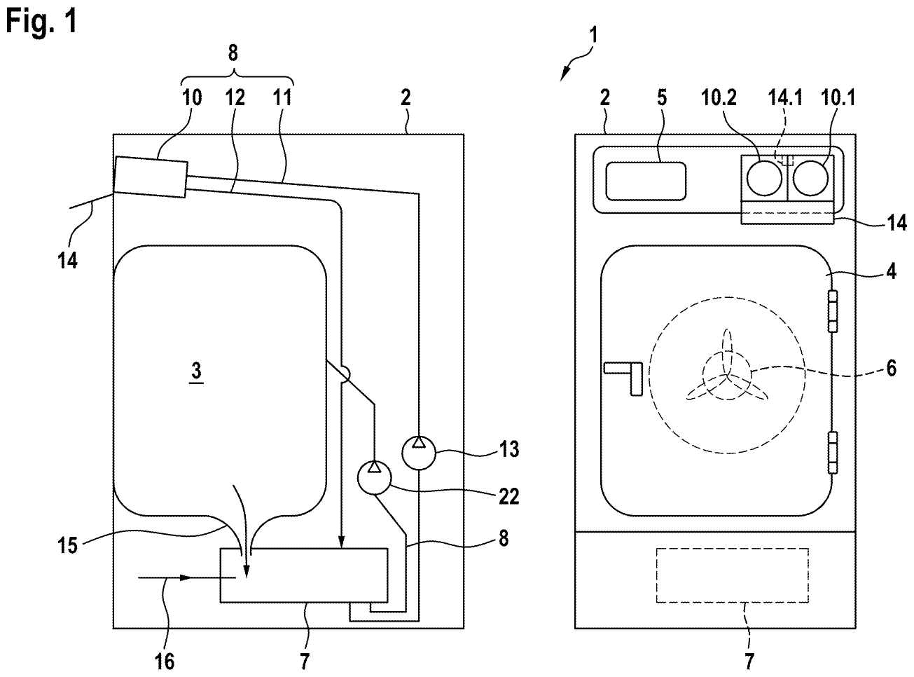

FIG. 1 is a schematic side view and a schematic front view of the kitchen and/or gastronomic appliance. According thereto, the kitchen and/or gastronomic appliance 1 comprises a housing 2. A food chamber 3, for storing and/or for treating food, is located in said housing 2. Said food chamber 3 is closed by means of a door 4.

A heating/circulating air unit 6, which can be operated via a control unit 5, is located in and/or on the food chamber 3. By means of the heating/circulating air unit 6 the food chamber 3, in particular configured as a cooking chamber, can be heated and optionally supplied with steam.

A collecting container 7 for the washing liquor is located inside the housing 2, under the food chamber 3. A washing liquor line 8 leads from said collecting container 7 to the food chamber 3. The washing liquor can be conducted out of the collecting container 7 into the food chamber 3, by means of a washing liquor pump 22. A return line 15 for guiding the washing liquor into the collecting container 7 is located at the lower end of the food chamber 3. This enables circulation of the washing liquor.

Two solids unit 9, specifically a first solids unit 9.1 and a second solids unit 9.2, are arranged in the housing 2. Unless a distinction is explicitly made between the two solids units, the embodiments of the kitchen and/or gastronomic appliance 1 described here always relate to both solids units, wherein they can be used selectively for one or for both of the solids units 9.

The first solids unit 9.1 comprises a first receptacle 10.1. The second solids unit 9.2 comprises a second receptacle 10.2. The receptacles 10 are in each case configured for insertion of a container 80. Solid additive 81, in the form of a cleaner or descaler/rinse aid, is located in the container 80.

As the schematic illustrations in FIG. 1 show, the receptacles 10 are located in the inside of the housing 2, over the food chamber 3. The receptacles 10 can be closed by means of a flap 14. By opening the flap 14, it is possible to insert the container 80 into the receptacles 10 or to replace said container.

A flap sensor 14.1 is located in the region of the flap 14, which sensor can detect whether the flap 14 is open or closed.

Furthermore, the individual solids unit 9 in each case comprises a supply line 11, through which the fluid can be conducted out of the collecting container 7 as far as the receptacle 10. As will be explained in detail below, the supply line 11 can be formed by a first supply line 11.1, a second supply line 11.2, or optionally also by a common supply line 11.3.

A discharge line 12 leads from the respective receptacle 10 to the collecting container 7; as will be explained in detail, said discharge line is a first discharge line 12.1, a second discharge line 12.2, and optionally a common discharge line 12.3.

A supply line pump 13 pumps the fluid out of the collecting container 7 to the receptacle 10. In detail, a first supply line pump 13.1, a second supply line pump 13.2, or optionally a common supply line pump 13.3, can be used.

FIG. 1 illustrates, purely schematically, a fresh water supply line 16 which makes it possible to fill the collecting container 7 with fresh water.

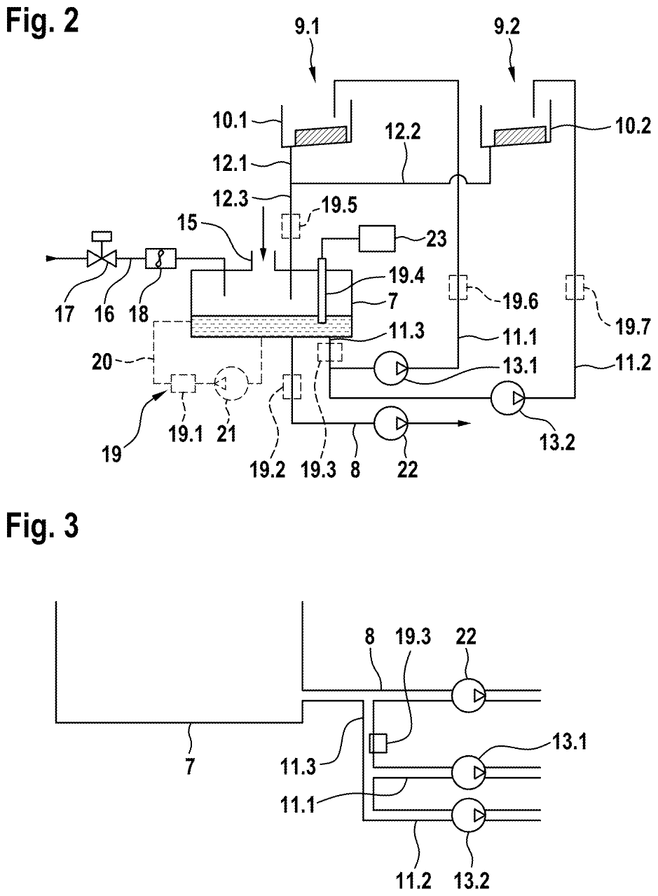

The schematic illustration in FIG. 2 shows that a fresh water valve 17 and a flow sensor 18 can be located in the fresh water supply line 16, as was explained in the general part of the description.

Furthermore, it has been explained in the general part of the description that the kitchen and/or gastronomic appliance 1 preferably comprises a sensor 19, by means of which the control variable can be determined. Said control variable is in turn dependent on the concentration of additive.

The sensor 19 is in particular connected to a controller 23 of the kitchen and/or gastronomic appliance 1. Said controller 23 is illustrated purely schematically in FIG. 2. The controller 23 can, as has been explained in the general part of the description, actuate at least the supply line pumps 13, depending on the control variable which is determined by the sensor 19.

FIGS. 2 and 3 illustrate that the sensor 19 can be used at different positions. As has already been described, it is also possible to use a plurality of the sensors 19 at said different positions.

A first sensor position 19.1 is located in a circulation line 20, which branches off from the collecting container 7 and leads directly back into the collecting container 7. A circulation pump 21 can be located in said circulation line 20.

A second sensor position 19.2 is located in the washing liquor line 8.

A third sensor position 19.3 is located in the common supply line 11.3. Said common supply line 11.3 branches off either, according to FIG. 2, from the collecting container 7, or, according to FIG. 3, from the washing liquor line 8. The common supply line 11.3 splits into the first supply line 11.1 and the second supply line 11.2.

A fourth sensor position 19.4 is located in the collecting container 7 and detects the control variable directly in the washing liquor which is located in the collecting container 7.

A fifth sensor position 19.5 is located in the common discharge line 12.3. The first discharge line 12.1 and the second discharge line 12.2 lead into said common discharge line 12.3, which in turn leads to the collecting container 7. Alternatively, it is also possible to place one sensor 19 in each case in the first discharge line 12.1 and in the second discharge line 12.2.

A sixth sensor position 19.6 is located in the first supply line 11.1, in particular downstream of the associated first supply line pump 13.1.

A seventh sensor position 19.7 is located in the second supply line 11.2, in particular downstream of the associated second supply line pump 13.2. It is in particular provided to use two of the sensors 19, once at the sixth position 19.6 and once at the seventh position 19.7.

FIGS. 2 and 3 each show a pump in the first supply line 11.1 and in the second supply line 11.2, specifically the first supply line pump 13.1 and the second supply line pump 13.2.

Alternatively hereto—according to FIG. 9—a common supply line pump 13.3 can also be used. In this case, the common supply line 11.3 leads to the common supply line pump 13.3. The pump can pump selectively into the first supply line 11.1 or into the second supply line 11.2, for example by changing its rotation direction. This is explained in the general part of the description, and applies correspondingly for the embodiment.

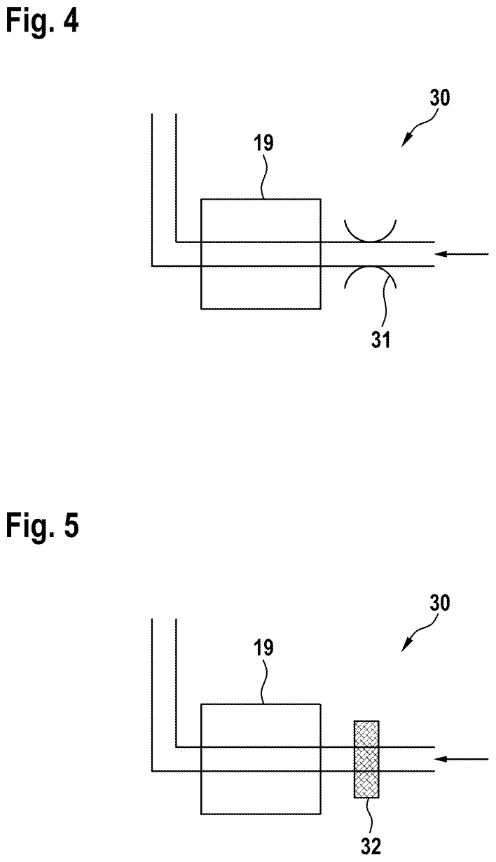

FIGS. 4 to 8 illustrate, purely schematically, different embodiments of a protection assembly 30, which can be used individually or in combination for protecting the sensor 19 from contamination.

FIG. 4 shows that a flow element 31 for cross-sectional narrowing can be used upstream of the sensor 19. Said flow element 31 increases the flow rate, as a result of which backflushing of the sensor 19 is possible.

FIG. 5 shows that a sieve 32 can be inserted upstream of the sensor 19, in order to hold back any dirt particles.

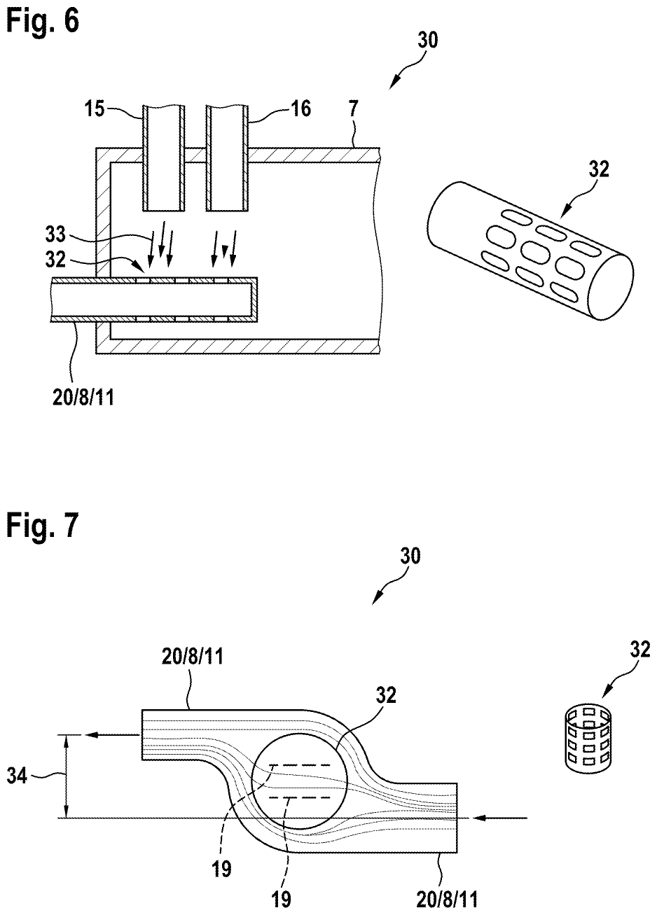

FIG. 6 shows that a sieve 32 of this kind can be inserted not only in a flow channel, but rather also in the collecting container 7. FIG. 6 shows, purely schematically, that a line leads out of the collecting container, specifically for example the circulation line 20, the washing liquor line 8, or the supply line 11. The sieve 32 is located in the inside of the collecting container, which sieve as far as possible prevents dirt particles from penetrating into the circulation line 20, the washing liquor line 8, or the supply line 11. However, the sensor 19 can also be located directly at a similar position, and be covered by the sieve 32.

FIG. 6 shows that the sieve 32 is positioned in the collecting container 7 in such a way that a line leading into the collecting container 7 is directed towards the sieve 32, for backflushing of the sieve. A backflushing 33 is shown schematically, which in this case acts on the sieve 32. Said line that leads into the collecting container can for example be the return line 15, the fresh water supply line 16, or also one of the discharge lines 12.

FIG. 7 shows, purely schematically, the arrangement of the sensor 19 comprising a sieve 32, surrounding the sensor 19, in the flow channel, i.e. in particular in one of the lines in which the sensor 19 can be arranged, according to sensor positions 19.1 to 19.7. FIG. 7 shows that, in this case, the incident flow onto the sieve 32 can take place tangentially. Accordingly, the flow channel before the sieve 32 is shifted by an offset 34 relative to the flow channel after the sieve 32, such that the tangential incident flow occurs.

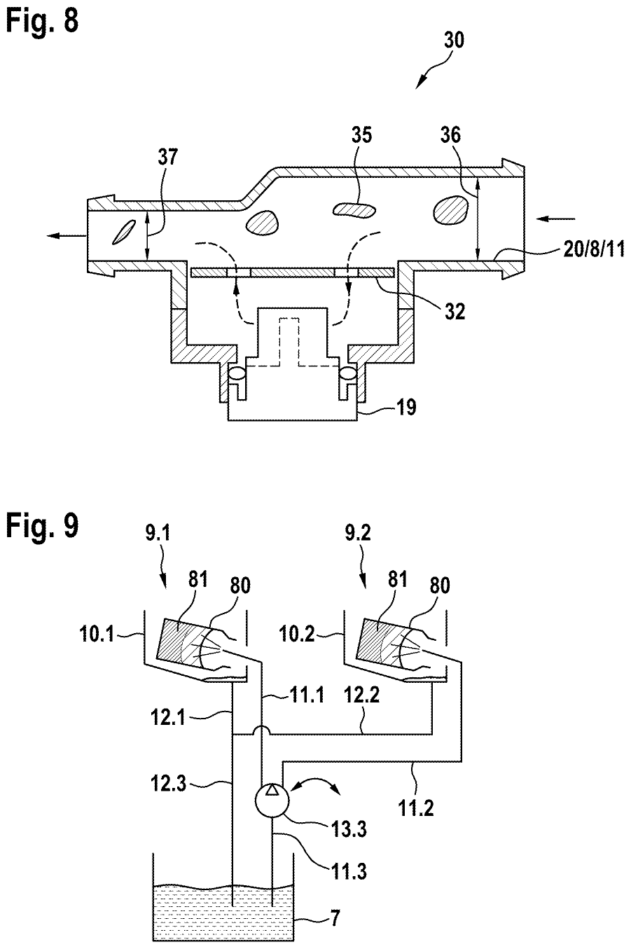

FIG. 8 shows, purely schematically, that the sensor 19 can be arranged beside the flow channel, wherein the sieve 32 separates the sensor 19 from the flow channel. As a result, any dirt particles 35 in the flow channel are transported onwards, and do not clog the sieve 32.

In particular, FIG. 8 shows that a first flow cross-section 36 can be configured to be larger than a second flow cross-section 37. In this case, the first flow cross-section 36 is located upstream of the second flow cross-section 37. This design of the two flow cross-sections 36, 37 produces a Venturi effect—as in the case of a Venturi nozzle—which generates a flow through the sieve 32 and thus to the sensor 19.

The line shown according to FIG. 7 or FIG. 8, for forming the flow channel, can in particular be the circulation line 20, the washing liquor line 8 or the supply line 11.

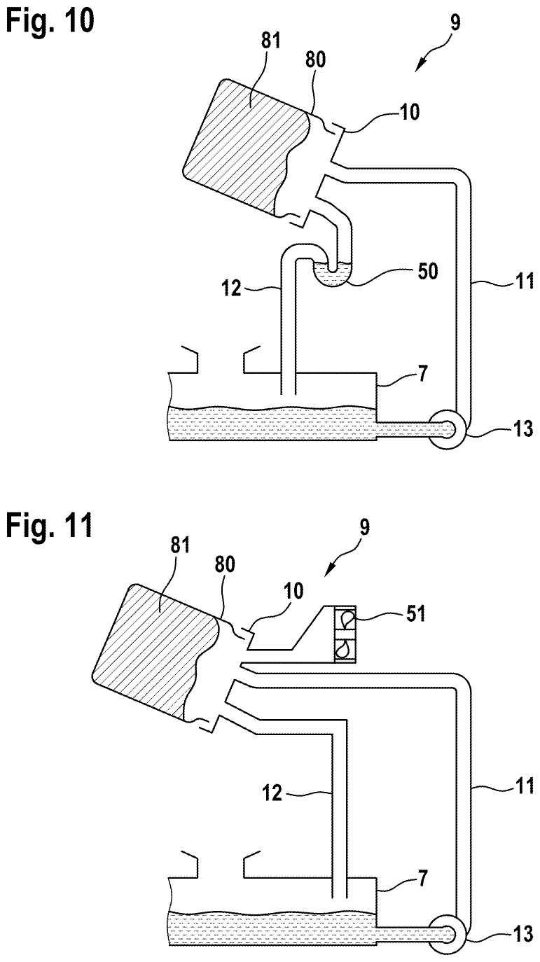

FIG. 10 shows that a siphon 50 can be used in the discharge line 12. The siphon 50 serves in particular as a vapor barrier, such that any vapor from the collecting container 7 does not lead to undesired dissolving and/or heating of the additive 81 in the container 80.

FIG. 11 shows, purely schematically, that the additive 81 can be dried by means of a fan 51, the airflow of which is directed to the receptacle 10. This also makes it possible, in addition or alternatively to the siphon 50, to prevent undesired dissolving and/or heating of the additive 81.

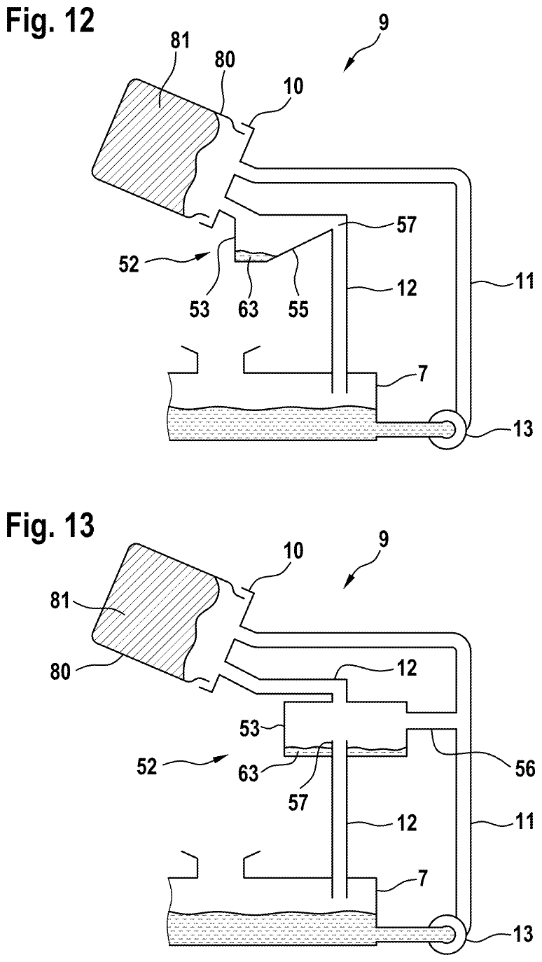

FIG. 12 and following show the use of a collecting arrangement 52, by means of which excess additive 63, which in particular flows out of the container 80 in a viscous state, can be collected.

For this purpose, the collecting arrangement 52 can comprise an intermediate container 53, as is shown for example in FIG. 12. Said intermediate container 53 is located in the discharge line 12 and in this case can either be connected to the receptacle 10 via a line, or can directly adjoin the receptacle 10.

FIG. 12 shows that the intermediate container 53 can comprise an overflow 57, such that a certain amount of fluid can be held in the intermediate container 53.

The base 55 of the intermediate container 53 can rise towards the overflow 57.

FIG. 13 shows that a flushing line 56 can lead into the intermediate container 53. Said flushing line 56 branches off from the supply line 11.

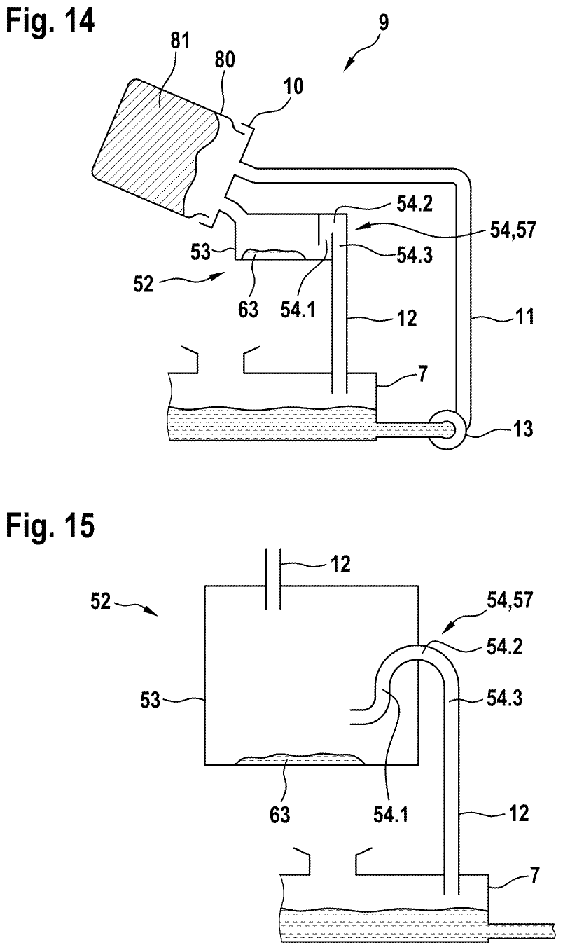

FIGS. 14, 15 and 16 show the design of the overflow 57 as a suction lifter 54. In this case, it is shown that the suction lifter 54 comprises a rising flow channel 54.1 and a falling flow channel 54.3. The two flow channels 54.1 and 54.3 are interconnected via a transition 54.2. If the fluid level in the intermediate container 53 rises above said transition 54.2, self-emptying of the intermediate container 53 occurs.

FIG. 14 shows that the suction lifter 54 can be achieved by a simple arrangement of partition walls.

According to FIG. 15, the suction lifter 54 can be achieved by a corresponding design of a curved pipe.

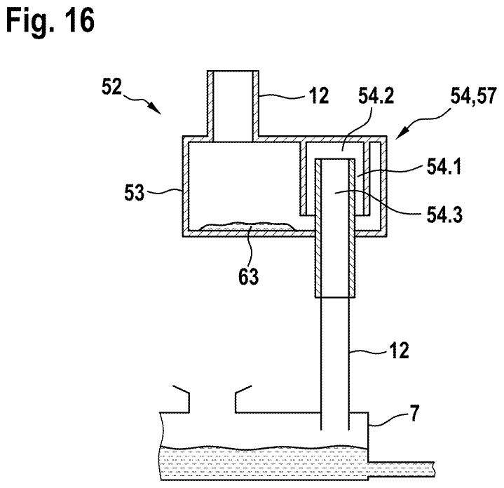

FIG. 16 shows the embodiment of the suction lifter 54 by way of two lengths of pipe protruding into one another, such that the rising flow channel 54.1 is formed radially outside of the inner pipe, and the falling flow channel 54.3 is formed inside the inner pipe.

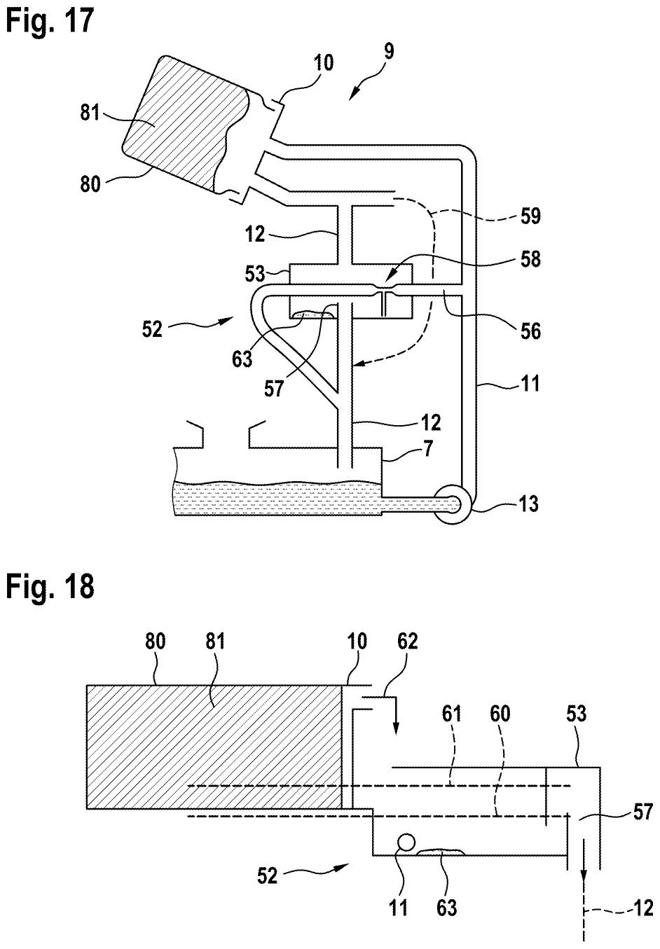

FIG. 17 shows that the flushing line 56 does not, as is shown in FIG. 13, have to lead into the intermediate container 53, but rather can also lead through a Venturi nozzle 58. Fluid can be suctioned out of the intermediate container 53 by means of said Venturi nozzle 58. Downstream of the Venturi nozzle 58, the flushing line 56 leads into the discharge line 12 or alternatively directly into the collecting container 7.

Irrespective of the collecting line 56 and the Venturi nozzle 58, FIG. 17 shows that a bypass 59 can be used, which branches off between the receptacle 10 and intermediate container 53, and conducts any excess fluid towards the collecting container 7, bypassing the intermediate container 53.

FIG. 18 illustrates the arrangement of the intermediate container 53 at the same height as the receptacle 10. In this case, it is in particular provided that the supply line 11 leads into the intermediate container 53, and thus leads via the intermediate container 53 indirectly to the receptacle 10. FIG. 18 shows a first water level 60 and a second water level 61, which can be achieved in particular by actuation of the supply line pump 13. Filling to the second water level 61 causes the receptacle 10 or the container 80 to be flooded, and results in dissolving of the additive 81 out of the container 80. By lowering to the first water level 60, primarily only the intermediate container 53 is still under water in part, as a result of which any excess additive 63 located in the intermediate container 53 is dissolved.

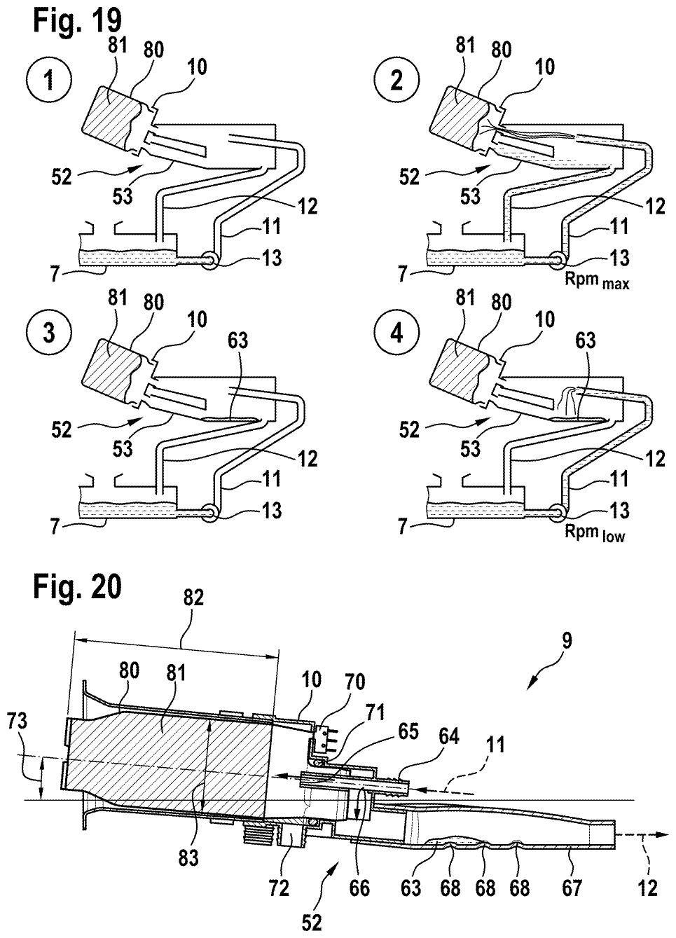

FIG. 19 shows, purely schematically, on the basis of four different illustrations, that the supply line 11 can be configured to selectively conduct the fluid to the receptacle 10, for dissolving the additive 81, or into the collecting arrangement 52, in particular the intermediate container 53. Illustration 1 in FIG. 19 shows the state without the supply line pump 13 being in operation. According to illustration 2, the supply line pump 13 is in operation at a relatively high speed. As a result, the fluid sprays over a correspondingly large distance, and can strike the additive 81.

Illustration 3 in FIG. 19 shows that, after such a process for dissolving the additive 81, excess additive 63 can collect in the intermediate container 53. If, according to illustration 4 in FIG. 19, the supply line pump 13 is now operated at a correspondingly low speed, then the fluid does not spray as far as the additive 81, but rather flows into the intermediate container 53 and can absorb the excess additive 63.

FIG. 20, for example, shows the way in which this progression, set out in FIG. 19, can be configured structurally.

FIG. 20 shows the receptacle 10 comprising a plugged-in container 80. A feed nozzle 64 is visible, which forms the end of the supply line 11. Said feed nozzle 64 comprises a main opening 65 which is directed towards the receptacle 10 and thus towards the additive 81 in the container 80. A secondary opening 66 is located in particular in the lateral surface of the feed nozzle 64, through which secondary opening the fluid can emerge at a correspondingly low pressure, and can thereby flow directly into the collecting arrangement 52, bypassing the additive 81.

Irrespective of the use of the feed nozzle 64, FIG. 20 shows that the collecting arrangement 52 may comprise not an intermediate container 53 but rather a line element 67. Said line element 67 is arranged having a correspondingly small inclination and a corresponding length, such that the excess additive 63 collects in the line element 67 and does not readily flow into the collecting container 7.

In particular, the line element 67 is located directly following the receptacle 10, and thus in particular over the food chamber 3.

FIG. 20 also shows that a plurality of flow resistance elements 68 are formed in the line element 67, as is explained in the general part of the description.

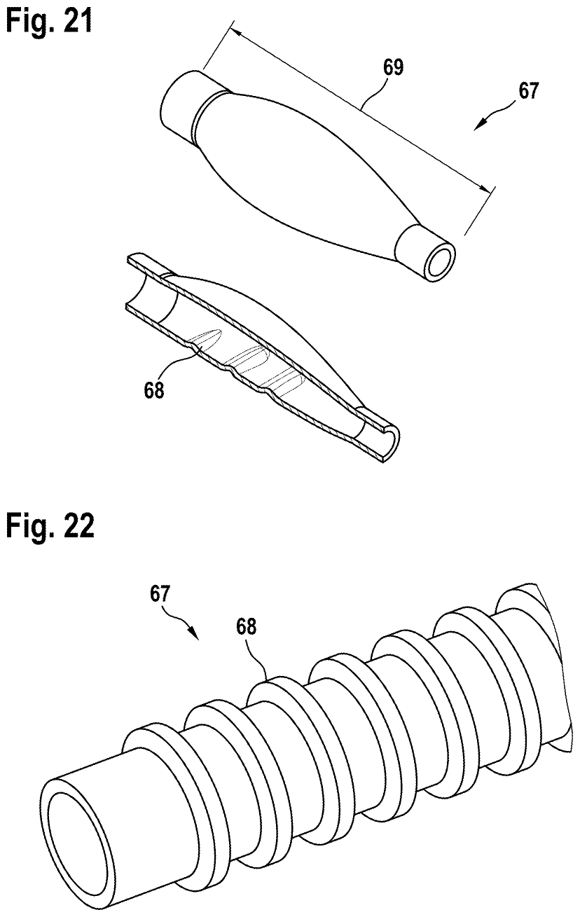

FIG. 21 shows the line element 67 with its line element length 69, which is in particular several cm. In the cut-open state, shown in FIG. 21, it can be seen that the line element 67 comprises correspondingly transverse flow resistance elements 68.

FIG. 22 shows an alternative embodiment for the line element 67. According thereto, a pipe can also be used as the line element 67, which pipe comprises peripheral thickenings (also referred to as beads). Said peripheral thickenings ultimately also form a plurality of flow resistance elements 68 on the base of the line element 67.

FIG. 20 further shows, irrespective of the structural embodiments shown in detail, that the receptacle 10 can comprise a container sensor 70. Said container sensor 70 detects whether the container 80 is inserted.

FIG. 20 further shows, irrespective of the structural embodiments shown in detail, that the receptacle 10 can comprise a container seal 71 which provides sealing with respect to the container 80.

FIG. 20 shows that the receptacle 10, irrespective of the structural embodiments shown in detail, can comprise a receptacle outlet 72. Said receptacle outlet 72 is arranged in particular outside of the container seal 71, in the receptacle 10, such that any fluid which collects in said outer space of the receptacle 10 can flow away.

FIG. 20 shows, irrespective of the structural embodiment shown in detail, that the receptacle 10 is configured for insertion of the container 80 at a receiving angle 73 relative to the horizontal. Said receiving angle 73 is preferably 1° to 20°.

FIG. 20 furthermore illustrates, irrespective of the structural embodiment shown, that the solid additive 81 in the container 80 prior to the first dissolving of the additive has an additive length 82 and an additive diameter 83. In this case, it is in particular provided that the additive length 82 is greater than the additive diameter 83.

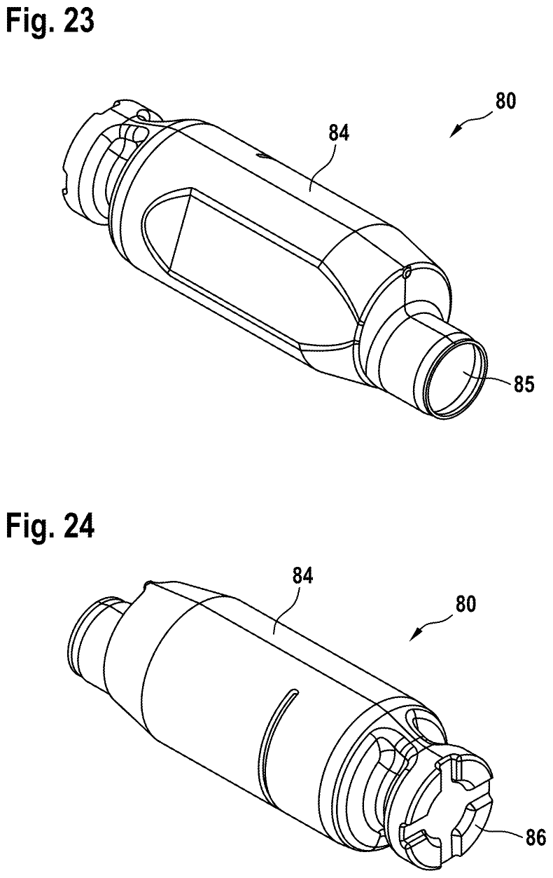

FIGS. 23 and 24 are two different views of a possible embodiment of the container 80 made of plastics material. These figures show that the container 80 has an outside contour 84, which in particular comprises at least one flattening.

It is furthermore preferably provided that the first receptacle 10.1 has a different inner contour than the second receptacle 10.2. This ensures that only the correct container 80 can also be inserted into the correct receptacle 10.

Furthermore, FIGS. 23 and 24 show that the container 80 has an asymmetrically arranged opening 85. A grip element 86 is located opposite the opening 85.

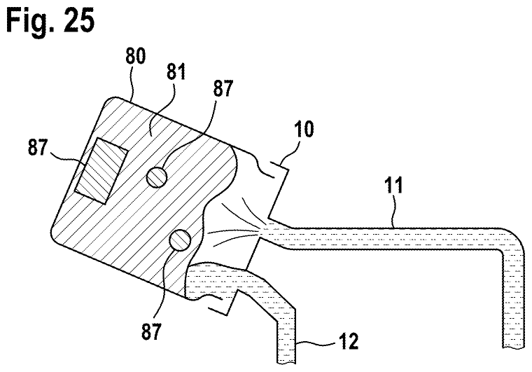

FIG. 25 illustrates, purely schematically, that a plurality of indicator elements 87 can be arranged in the additive 81 in the container 80. Said indicator elements 87 composed of indicator substance can be dissolved using the fluid. As a result, the filling level of additive 81 in the container 80 can be determined, as is explained in the general part of the description.

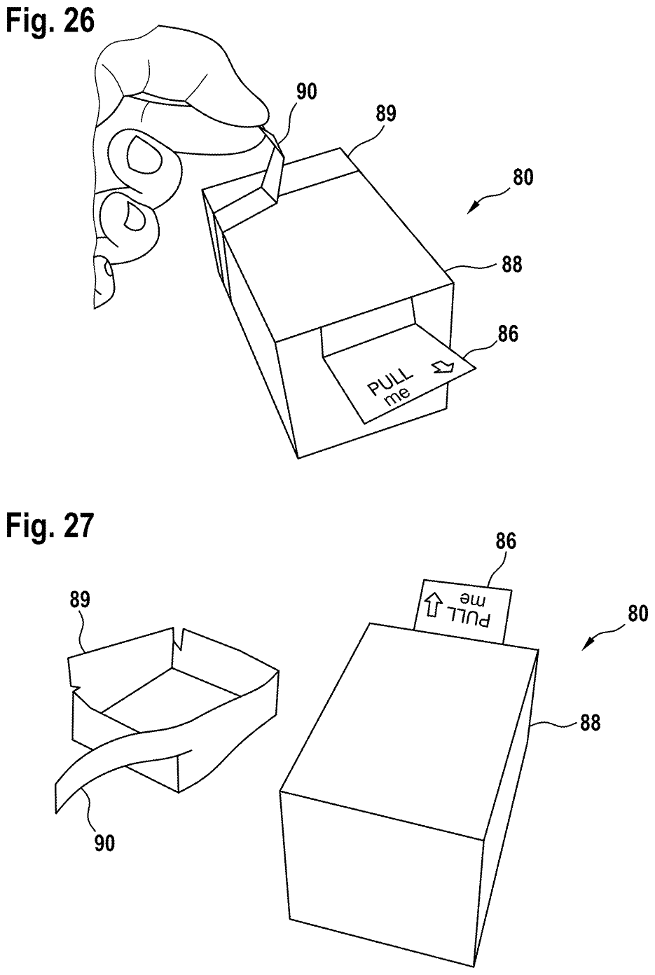

FIG. 26 shows that, irrespective of the exact embodiment of the container 80, the container 80 can comprise a main body 88 for receiving the additive 81, and a lid 89. The lid 89 closes the main body 88.

FIG. 26 illustrates that the lid can be connected to the main body 88 for example by a pull tab 90.

FIG. 27 shows the torn-open pull tab 90 and the removed lid 89.

FIGS. 26 and 27 illustrate that a multilayer material, for example in the manner of a Tetra Pak, can be used for the container 80.

What is claimed is:

1. A kitchen and/or gastronomic appliance, in particular a cooking appliance, comprising:
a food chamber for treating and/or storing food, in particular configured as a cooking chamber,
a collecting container for storing a liquid washing liquor,
a washing liquor line for conducting the washing liquor out of the collecting container into the food chamber,
at least one solids unit, having:
a receptacle for insertion of a container comprising a solid additive,
a supply line leading to the receptacle for supplying a fluid that dissolves the additive,
and a discharge line that leads from the receptacle in the direction of the collecting container and is intended for removing the fluid together with the dissolved additive, and
at least one supply line pump for pumping the fluid, preferably the washing liquor, through the at least one supply line.

2. The kitchen and/or gastronomic appliance of claim 1, comprising two of the solids units, specifically:
a first solids unit having a first receptacle for insertion of a container comprising solid additive, in particular detergent, a first supply line leading to the first receptacle and intended for supplying the fluid that dissolves the additive, and a first discharge line, for removing the fluid together with dissolved additive, that leads from the first receptacle in the direction of the collecting container, and
a second solids unit having a second receptacle for insertion of a container comprising solid additive, in particular descaler or rinse aid, a second supply line leading to the second receptacle and intended for supplying the fluid that dissolves the additive, and a second discharge line, for removing the fluid together with dissolved additive, that leads from the second receptacle in the direction of the collecting container.

3. The kitchen and/or gastronomic appliance of claim 2, comprising a first supply line pump for pumping the fluid through the first supply line, and a second supply line pump for pumping the fluid through the second supply line.

4. The kitchen and/or gastronomic appliance of claim 2, comprising a common supply line pump for pumping the fluid through the first supply line and the second supply line.

5. The kitchen and/or gastronomic appliance of claim 4, wherein the common supply line pump is configured for selectively conveying the fluid into the first supply line and into the second supply line, or comprising a valve downstream of the common supply line pump for selectively conducting the fluid into the first supply line and into the second supply line.

6. The kitchen and/or gastronomic appliance of claim 2, wherein the first discharge line and the second discharge line lead into a common discharge line, wherein the common discharge line leads into the collecting container.

7. The kitchen and/or gastronomic appliance of claim 2, wherein a common supply line branches off from the collecting container or from the washing liquor line, which common supply line splits into the first supply line and the second supply line.

8. The kitchen and/or gastronomic appliance of claim 1, comprising at least one sensor, preferably a conductivity sensor, for determining a control variable which is dependent on the concentration of additive; preferably:
wherein the sensor is arranged in the washing liquor line,
and/or wherein the sensor is arranged in the supply line,
and/or wherein the sensor is arranged in the discharge line,
and/or wherein the sensor is arranged in a circulation line which circulates the washing liquor, bypassing the food chamber and the additive unit(s).

9. The kitchen and/or gastronomic appliance of claim 8, wherein the kitchen and/or gastronomic appliance is configured to actuate the at least one supply line pump depending on the control variable, preferably to switch said pump on and off and/or to change its speed and/or to change its discharge rate.

10. The kitchen and/or gastronomic appliance of claim 1, wherein the kitchen and/or gastronomic appliance is configured to detect an indicator variable in the fluid, which depends on a concentration of an indicator substance which can be positioned at a defined position in the additive and can be dissolved out of the additive by the fluid.

11. The kitchen and/or gastronomic appliance of claim 8, comprising a protection assembly for the sensor; preferably:
wherein the protection assembly comprises a flow element that narrows the cross-section, upstream of the sensor, for increasing the flow rate,
and/or wherein the kitchen and/or gastronomic appliance is configured to actuate a pump, which conveys the fluid past the sensor, in a pulsating manner, for cleaning the sensor.

12. The kitchen and/or gastronomic appliance of claim 11, wherein the protection assembly comprises a sieve upstream of or on the sensor, preferably:
wherein the sieve is arranged in the collecting container and at least one line which leads into the collecting container is directed towards the sieve for backflushing of the sieve,
or wherein the sieve separates the sensor from a flow channel,
or wherein the sieve protrudes into the flow channel of the fluid, and in this case in particular receives a tangential incident flow.

13. The kitchen and/or gastronomic appliance of claim 1, comprising a siphon in the discharge line as a vapor barrier between the collecting container and the at least one receptacle.

14. The kitchen and/or gastronomic appliance of claim 1, comprising at least one fan and/or ventilation opening and/or chimney, the airflow of which for drying the additive leads to the receptacle.

15. The kitchen and/or gastronomic appliance of claim 1, wherein the at least one solids unit comprises a collecting arrangement in the discharge line for collecting excess additive.

16. The kitchen and/or gastronomic appliance of claim 15, wherein the collecting arrangement comprises an intermediate container, wherein the discharge line leads through the intermediate container, in the direction of the collecting container.

17. The kitchen and/or gastronomic appliance of claim 16, wherein the intermediate container comprises an overflow leading to the collecting container.

18. The kitchen and/or gastronomic appliance of claim 17, wherein a base of the intermediate container rises obliquely to the overflow.

19. The kitchen and/or gastronomic appliance of claim 17, wherein the overflow is configured as a suction lifter, in that the overflow comprises a rising flow channel, a falling flow channel, and a transition connecting the two flow channels, wherein the intermediate container can be filled higher than the transition for self-emptying.

20. The kitchen and/or gastronomic appliance of claim 16, comprising a flushing line which leads to the intermediate container, bypassing the receptacle; preferably wherein the flushing line branches off from the supply line downstream of the supply line pump.

21. The kitchen and/or gastronomic appliance of claim 20, wherein the flushing line leads into the intermediate container; or wherein the flushing line suctions out of the intermediate container by means of a Venturi nozzle, and leads into the discharge line or into the collecting container, downstream of the intermediate container.

22. The kitchen and/or gastronomic appliance of claim 16, wherein the intermediate container is connected to the receptacle by means of a line, in particular a tube and/or a pipe, or wherein the intermediate container is connected to the receptacle directly, in particular without an intermediate line.

23. The kitchen and/or gastronomic appliance of claim 16, wherein the intermediate container is arranged at the height of the receptacle, such that a first fluid level in the intermediate container floods the receptacle for dissolving the additive, and a second fluid level, which is lower than the first fluid level and greater than zero, does not flood the receptacle or floods it only to a lesser extent.

24. The kitchen and/or gastronomic appliance of claim 15, wherein the collecting arrangement comprises a line element for collecting excess additive; preferably having
a line element length of at least 5 cm, preferably at least 10 cm,
and/or having a downward gradient of at most 30°, preferably at most 20°,
and/or at least one flow resistance element, preferably a plurality of flow resistance elements, on the base of the line element.

25. The kitchen and/or gastronomic appliance of claim 15, wherein the supply line is configured to conduct the fluid, preferably depending on the pressure in the supply line, selectively to the receptacle in order to dissolve the additive, and into the collecting arrangement.

26. The kitchen and/or gastronomic appliance of claim 24, wherein a feed nozzle of the supply line is configured and positioned in such a way that, at a first pressure in the supply line, the fluid is conducted into the collecting arrangement, and at a second pressure which deviates from the first pressure and is preferably higher than the first pressure, the fluid can be conducted to the receptacle, for dissolving the additive.

27. The kitchen and/or gastronomic appliance of claim 1, comprising
a return line for guiding the washing liquor out of the food chamber into the collecting container,
and/or a washing liquor pump for pumping the washing liquor through the washing liquor line,
and/or a fresh water supply line, preferably having an actuatable freshwater valve and/or having a flow sensor, for feeding fresh water into the collecting container,
and/or a flap on the receptacle, which flap can be actuated for insertion of the container,
and/or a flap sensor, in particular brightness sensor, for detecting an open and/or a closed state of the flap,
and/or a container sensor for detecting an inserted container.

28. A container, filled with solid additive, in particular cleaner or descaler or rinse aid, configured for insertion into the receptacle of the kitchen and/or gastronomic appliance of claim 1.

29. The container of claim 28, comprising at least one indicator element having indicator substance at a defined position in the additive, wherein the indicator element can be dissolved from the additive by the fluid; preferably wherein the indicator element changes the conductivity more than the additive.

30. The container of claim 29, wherein at least two indicator elements are arranged in the additive at different positions, in order to determine the use of additive in at least two stages.

31. The container of claim 28, wherein the container is manufactured from a multilayer material, wherein the multilayer material comprises at least one first layer and one second layer, wherein the first layer is made of paper or card, and the second layer is made of plastics material or metal.

32. The container of claim 28, wherein the container comprises a main body and a lid which covers the surface of the additive; preferably:
wherein the lid is connected to the main body of the container via a pull tab (90),
and/or wherein the lid is adhesively bonded or welded to the main body,
and/or wherein the lid can be removed from the main body without tools,
and/or wherein the lid can be removed from the main body, and in particular placed thereon again, in a non-destructive manner,
and/or comprising a connection portion, which connects the removed lid to the main body.
